(19) United States
(12) Patent Application Publication
(10) Pub. No.: US 2009/0151856 A1
(43) Pub. Date: Jun. 18, 2009

(54) TIRE HAVING SIDEWALL WITH INTEGRAL COLORED MARKING COMPOSITE

(75) Inventors: George Frank Balogh, North Canton, OH (US); Leonard James Reiter, Norton, OH (US); James Alfred Benzing, II, North Canton, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(73) Assignee: The Goodyear Tire & Rubber Company

(21) Appl. No.: 12/391,758

(22) Filed: Feb. 24, 2009

Related U.S. Application Data
(62) Division of application No. 11/429,872, filed on May 8, 2006.

(51) Int. Cl. B29D 30/72

(52) U.S. Cl. 156/116

(57) ABSTRACT

This invention relates to a tire with a rubber sidewall having at least one layered rubber composite integral with a portion of its outer surface as a means of visibly identifying the tire. The layered composite is an integral composite in a sense of being comprised of a base rubber layer and a contrastingly colored marking rubber layer being partially pre-cured together prior to application to the outer surface of an uncured rubber sidewall. The integrally layered composite and tire rubber sidewall are integral in a sense of being co-cured together with the surface of the base rubber layer facing the rubber sidewall surface. The base rubber layer is a black colored carbon black reinforced rubber layer. The marking rubber layer is of color which contrasts with the black color of the base rubber layer. The base layer is a protective rubber layer which extends beyond the peripheral edges of said marking layer and is protective in a sense of inhibiting, or retarding, discoloring materials from migrating through it to the contrastingly colored marking layer.

### FIELD OF THE INVENTION

This invention relates to a tire with a rubber sidewall having at least one layered rubber composite integral with a portion of its outer surface as a means of visibly identifying the tire. The layered composite is an integral composite in a sense of being comprised of a base rubber layer and a contrastingly colored marking rubber layer being partially pre-cured together prior to application to the outer surface of an uncured rubber sidewall. The integrally layered composite and tire rubber sidewall are integral in a sense of being co-cured together with the surface of the base rubber layer facing the rubber sidewall surface. The base rubber layer is a black colored carbon black reinforced rubber layer. The marking rubber layer is of color which contrasts with the black color of the base rubber layer. The base layer is a protective rubber layer which extends beyond the peripheral edges of said marking layer and is protective in a sense of inhibiting, or retarding, discoloring materials from migrating through it to the contrastingly colored marking layer.

### BACKGROUND OF THE INVENTION

Pneumatic rubber tires are composed of a plurality of components which conventionally include sidewalls which are subject to considerable flexing and scuffing during use of the tire, a phenomenon well known to those having skill in such art.

Sometimes various pneumatic tires, such as for example large sized pneumatic tires, are used on various vehicles, sometimes to haul significant loads. For such purpose, it is considered herein to be an advantage to provide such tire with a visible marking in order that nearby workers can readily perceive if and when such tires are in motion. In practice, the sidewalls of such tires may be simply marked with a plurality of spaced apart colored markings in which it can be readily be discerned when the tire is in motion when the tire is being run at a slow speed.

However, in practice, various chemical ingredients typically contained within the tire sidewall rubber composition, (e.g. amine based antidegradants, which may sometimes be referred to as staining antidegradants, and various rubber processing oils), which tend to migrate through the rubber of the sidewall to the sidewall surface and thereby tend to discolor such markings to make them somewhat difficult to easily visually discern. Such migrative rubber discoloring phenomenon is well known to those having skill in such art.

Accordingly, it is desired herein to provide a tire having a black colored rubber sidewall with a plurality of spaced apart visible non-black colored integral rubber laminates (e.g. laminates in a form of identifying contrastingly colored markings) to enable motion of the tire to be readily visually observed and to therefore readily discern whether the tire is moving (e.g. rotating) by a casual observer whose attention may be focused on another activity.

Historically, rubber tires have heretofore been provided with various labels in a form of, for example, decals, various indicia and applique by various methods for various purposes. For example, see U.S. Pat. Nos. 4,252,589, 5,047,110, 5,993,961, 6,221,435, 6,235,363, 6,235,376 and 6,391,134.

For this invention, it is desired to provide an identifying marking on a tire sidewall other than a simple thin paint-type coating and other than application to an already cured tire rubber sidewall. In practice, such identifying marking is hereby provided on the sidewall of a tire of a layered rubber composite integral with said tire sidewall in a sense of being co-cured wherewith which is comprised of a base rubber layer and an outer marking rubber layer, where the outer marking rubber layer is of a color which contrasts with the black color of the carbon black reinforced tire rubber sidewall.

In practice, the identifying rubber composite marking (layered integral rubber composite) is partially pre-cured form an integral layered composite prior to its application to an uncured tire sidewall rubber.

The partially pre-cured integral layered composite is applied to the surface of the uncured tire rubber sidewall, with the base layer of the composite facing the rubber sidewall surface, to form an assembly thereof and the resulting assembly then placed in a suitable mold in which the tire including the tire sidewall and applied partially pre-cured layered composite, is cured at an elevated temperature by which the applied partially pre-cured rubber composite is co-cured with the tire sidewall to provide an integral composition.

In practice, then, the base rubber layer of the composite is positioned next to the uncured tire rubber sidewall and contains carbon black reinforcement so that it is black in color.

The underlying base layer of the layered composite extends beyond the peripheral edges of the outer marking rubber layer (and positioned between the tire sidewall and the outer marking rubber layer) in a manner for the base rubber layer to retard, or inhibit, migration of antioxidants, particularly amine-containing staining antioxidants, from the tire sidewall rubber to the outer marking non-black colored rubber layer of the layered composite.

The layered composite is partially pre-cured prior to its application to the uncured tire sidewall surface in order to provide a degree of dimensional stability, or integrity, to the layered composite, including its outer marking layer, during the curing of the assembly in the mold in order to retard its flow, or tendency to flow, during such curing of the assembly in the associated mold at an elevated temperature and pressure. Such tendency of uncured rubber components of an article, such as for example a tire, to flow during curing within an associated mold at an elevated temperature and pressure is well understood by one having skill in such rubber molding art.

Accordingly, it is believed that such methodology and resulting tire with its integral sidewall contrastingly colored identifying marking is a departure from past practice.

In the description of this invention, the term “phr” is used to designate parts by weight of a material per 100 parts by weight of elastomer. The terms “rubber” and “elastomer” may be used interchangeably unless otherwise indicated. The terms “vulcanized” and “cured” may be used interchangeably, as well as “unvulcanized” or “uncured”, unless otherwise indicated. The terms “compound” and “rubber composition” may be used interchangeably unless indicated. The term “carbon black” is used to refer to rubber reinforcing carbon blacks unless otherwise indicated. Exemplary rubber reinforcing carbon blacks may be referred to, for example, in The Vanderbilt Rubber Handbook (1987) on Pages 414 through 417.

### DISCLOSURE AND PRACTICE OF INVENTION

In accordance with this invention a pneumatic rubber tire is provided having a rubber sidewall which contains at least one multi-layered rubber composite upon and integral with its outer surface (integral in a sense that the multi-layered rubber composite is co-sulfur cured together with the rubber sidewall), wherein said multi-layered rubber composite is comprised of two integral rubber layers (integral in a sense that they are partially co-sulfur cured together prior to application thereof to the tire rubber sidewall);

wherein said two rubber layers of said multi layered integral rubber composite are comprised of:

(A) an outer, visible marking rubber layer comprised of a non-black colored sulfur curable rubber composition containing a colorant having a color other than a black color to thereby color said marking rubber layer a color other than a black color; and

(B) a base rubber layer underlying and integral with said outer marking rubber layer comprised of a black colored, carbon black-containing, sulfur curable rubber composition,

wherein said base rubber layer extends beyond the peripheral edges of said marking rubber layer; and

wherein the face of said base rubber layer opposite said integral marking rubber layer is integral with said rubber sidewall (in the sense of being co-sulfur cured therewith).

In further accordance with this invention, said tire sidewall surface contains a plurality (e.g. from two to and including five) of said multi-layered composites configured in an annular spaced apart configuration relative to each other.

In practice, the rubber composition of said marking rubber layer desirably contains reinforcing filler comprised of at least one of clay, titanium dioxide and precipitated silica (to the substantial or complete exclusion of any significant black color-imparting amount of carbon black) and which contains a colorant having a color other than a black color to thereby color said outer marking rubber layer a color which contrasts with the black color of the carbon black-containing base layer (wherein it is to be appreciated that said titanium dioxide reinforcement may also serve as a white colored colorant).

In additional accordance with this invention, method of preparing a tire having a rubber sidewall with at least one multi-layered rubber composite on and integral with the surface of said rubber sidewall comprises the steps of:

(A) preparing a multi-layered rubber composite comprised of:
(1) an outer, visible marking rubber layer comprised of a non-black colored sulfur curable rubber composition containing a colorant having a color other than a black color to thereby color said marking rubber layer a color other than a black color; and
(2) a base rubber layer underlying said outer marking rubber layer comprised of a black colored, carbon black-containing, sulfur curable rubber composition,

wherein said base rubber layer extends beyond the peripheral edges of said marking rubber layer;

(B) partially co-sulfur curing said base rubber layer and said outer marking rubber layer of said multi-layered composite together to form an integral composite thereof,

(C) applying at least one of said integral multi-layered composites to an outer surface of an uncured rubber sidewall of a pneumatic tire to form an assembly thereof;

wherein the face of said base rubber layer opposite said integral marking rubber layer of said multi-layered composite is positioned against said outer surface of said tire rubber sidewall;

(D) co-curing said assembly in a suitable mold under conditions of elevated temperature and pressure.

In further accordance with this invention, said tire a plurality (e.g. from two to and including five) of said partially cured multi-layered rubber composites are applied to said outer surface of said tire rubber sidewall, wherein said rubber composites are configured in an annular spaced apart configuration relative to each other, to form said assembly.

In practice, said multi-layered rubber composite is partially co-sulfur cured, prior to said application to the surface of said uncured rubber sidewall to a degree of about 50 to about 80 percent of its rheometric delta torque value as the difference between its rheometric maximum torque (dNm) and minimum torque (dNm) according to ASTM D2084 as determined by a suitable rheometer instrument such as, for example an (ODR) instrument, Model ODR Rheometer OD2000 from Alpha Technologies. Such ODR instrument is believed to be well known to those having skill in such art for determining cure characteristics of elastomeric materials (rubber compositions), to include maximum and minimum torque values (dNm) in a sense of times to achieve percentages of cure of the rubber composition such as for example T50, T80 and T90 percent, respectively, which represent the time, in minutes to achieve 50, 80 and 90 percent, respectively, of the delta torque value as the difference of the maximum and minimum torque values as determined by the ODR instrument at a temperature for this characterization being 150° C.

In practice, the rubber composition of said marking rubber layer desirably contains reinforcing filler comprised of at least one of clay, titanium dioxide and precipitated silica (to the substantial or complete exclusion of any significant black color-imparting amount of carbon black) and which contains a colorant having a color other than a black color to thereby color said outer marking rubber layer a color which contrasts with the black color of the carbon black-containing base layer (wherein it is to be appreciated that said titanium dioxide reinforcement may also serve as a white colored colorant).

In additional accordance with this invention a tire is provided prepared according to said method.

In practice, the rubber composition of said rubber sidewall generally contains at least one amine-based antidegradant and at least one rubber processing oil.

In practice, the rubber composition of said base rubber layer of said multi-layered rubber composite may be comprised of, based on parts by weight per 100 parts by weight rubber (phr):

(A) at least one elastomer comprised of about 40 to about 90, alternately from about 40 to about 80, phr of at least one of:
(1) butyl rubber comprised of a copolymer of isobutylene and about 0.5 to about 5 mole percent of a conjugated diene, wherein said conjugated diene is preferably comprised primarily of isoprene;
(2) halogenated butyl rubber comprised of said butyl rubber halogenated with bromine or chlorine; and
(3) brominated copolymer of isobutylene and pare-methylstyrene; and

(B) from about 10 to about 60, alternately from about 20 to about 60 of additional elastomer(s) comprised of at least one of:
(1) conjugated diene-based elastomer, and
(2) EPDM (ethylene/propylene/non-conjugated diene elastomer) rubber.

In practice, the rubber composition of said base rubber layer of said multi-layered rubber composite may contain from about 10 to about 70 phr of reinforcing filler comprised of, based upon parts by weight per 100 parts by weight of rubber (phr):

(A) about 20 to about 60 phr of rubber reinforcing carbon black, or;

(B) about 20 to about 60 phr of rubber reinforcing carbon black and up to about 60 phr, alternately from about 10 to about 60 phr, of precipitated silica.

In practice, the rubber composition of said outer marking rubber layer of said multi-layered rubber composite may be comprised of, based on parts by weight per 100 parts by weight rubber (phr):

(A) at least one (butyl rubber type) elastomer comprised of about 40 to about 90, alternately from about 40 to about 80, phr of at least one of:
(1) butyl rubber comprised of a copolymer of isobutylene and about 0.5 to about 5 mole percent of a conjugated diene, wherein said conjugated diene is preferably comprised primarily of isoprene;
(2) halogenated butyl rubber comprised of said butyl rubber halogenated with bromine or chlorine; and
(3) brominated copolymer of isobutylene and pare-methylstyrene; and

(B) from about 10 to about 60, alternately from about 20 to about 60 of additional elastomer(s) comprised of at least one of:
(1) conjugated diene-based elastomer, and
(2) EPDM (ethylene/propylene/non-conjugated diene elastomer) rubber.

A significant aspect of the invention is for the base layer of said multi-layered composite to be comprised of said butyl rubber type elastomer(s) to thereby inhibit, or retard, the migration of staining ingredients, representative of which are amine-based antidegradants and various rubber processing oils to said outer colored marking layer of said multi-layered composite.

A further significant aspect of the invention is that for partially pre-cured laminate composite to be partially pre-cured state to provide a dimensionality to the multi-layered composite the thereby substantially retain its shape and inhibit the migration of staining ingredients during the curing of the assembly of sidewall and laminate composite because of the partially pre-cured form, or condition, of the laminate composite.

This is considered herein to be significant because staining ingredients would discolor the visible surface of the laminate and block, or significantly retard or inhibit, the aforesaid safety aspects of this invention.

Representative of various additional conjugated diene-based elastomers for the tire sidewall rubber composition of this invention are polymers of at least one of isoprene and 1,3-butadiene and copolymers of styrene and at least one of isoprene and 1,3-butadiene.

Such conjugated diene based elastomers may be comprised of, for example, cis 1,4-polyisoprene (natural and synthetic), cis 1,4-polybutadiene rubber, styrene/butadiene copolymer rubber, isoprene/butadiene rubber, styrene/isoprene/butadiene terpolymer rubber and high vinyl polybutadiene rubber having a vinyl 1,2-content in a range of from about 35 percent to about 90 percent.

It should readily be understood by one having skill in the art that the non-black colored tire sidewall rubber strip composition can be compounded by methods generally known in the rubber compounding art, such as mixing the various sulfur-vulcanizable constituent rubbers with various commonly-used additive materials such as, for example, curing aids, such as sulfur, activators, retarders and accelerators, processing additives, such as oils, resins including tackifying resins and plasticizers, fillers, pigments, stearic acid, zinc oxide, waxes, antioxidants and antiozonants (e.g. non-staining antioxidants and antiozonants), peptizing agents and non-black colored colorants, particularly comprised of, or containing, titanium dioxide pigment. As known to those skilled in the art, depending on the intended use of the sulfur-vulcanizable and sulfur-vulcanized materials (rubbers), the certain additives mentioned above are selected and commonly used in conventional amounts.

Such pneumatic tires are conventionally comprised of a generally toroidal-shaped carcass with an outer circumferential tread, adapted to be ground contacting, spaced beads and the aforesaid sidewall(s) extending radially from and connecting said tread to said beads.

Various phenol-containing antidegradants may be used in various amounts such as example, a range of from 1 to about 5 phr. Representative of such antidegradants may be, for example, polymeric hindered phenol antioxidants, and others, such as those included in The Vanderbilt Rubber Handbook (1978), within pages 344-347. As previously discussed, the phenol-containing, non-staining antioxidants are preferred where they have a significantly reduced ability to discolor the non-black colored sidewall rubber composition. Various waxes, particularly microcrystalline waxes, may be of the type shown in The Vanderbilt Rubber Handbook (1978), within Pages 346 and 347. Typical amounts of antiozonants may be, for example, from 1 to about 5 phr. Typical amounts of stearic acid (usually in a form of an industrial fatty acid composition which contains stearic acid, palmitic acid and oleic acid) may be, for example, from 1 to about 3 phr. Typical amounts of zinc oxide may be, for example, from 2 to about 5 phr. Typical amounts of waxes may be, for example, from 0 to about 5 phr. Typical amounts of peptizers, if used, may be, for example, from 0.1 to about 1 phr. The presence and relative amounts of the above additives are not considered herein as an aspect of the present invention unless otherwise indicated.

The vulcanization is conducted in the presence of a sulfur-vulcanizing agent. Examples of suitable sulfur-vulcanizing agents include elemental sulfur (free sulfur) or sulfur-donating vulcanizing agents, for example, an amine disulfide, polymeric polysulfide or sulfur olefin adducts. Preferably, the sulfur-vulcanizing agent is elemental sulfur. As known to those skilled in the art, sulfur-vulcanizing agents may be used in an amount ranging, for example, from about 0.5 to about 5 phr with a range of from about 0.5 to about 2.5 sometimes being preferred.

Accelerators are used to control the time and/or temperature required for vulcanization and to improve the properties of the vulcanizate. In one embodiment, a single accelerator system may be used, i.e., primary accelerator. Conventionally, a primary accelerator is used in amounts ranging, for example, from about 0.5 to about 3 phr. In another embodiment, combinations of two or more accelerators in which a primary accelerator is generally used in the larger amount (for example 0.5 to 1 phr), and a secondary accelerator which is generally used in smaller amounts (for example 0.05 to 0.50 phr) in order to activate and to improve the properties of the vulcanizate. Combinations of such accelerators have historically been known to produce a synergistic effect of the final properties of sulfur-cured rubbers and are often somewhat better than those produced by use of either accelerator alone. In addition, delayed action accelerators may be used which are less affected by normal processing temperatures but produce satisfactory cures at ordinary vulcanization temperatures. Representative examples of accelerators include, for example, amines, disulfides, guanidines, thioureas, thiazoles, thiurams, sulfenamides, dithiocarbamates and xanthates. Usually, amine-based accelerators are not desired because they are more vulnerable to discoloration of the non-black colored tire sidewall rubber composition. The primary accelerator may preferably be a sulfenamide. If a second accelerator is used, the secondary accelerator may be a guanidine, dithiocarbamate or thiuram compound, particularly diphenyl guanidine.

Non-black colored colorants (e.g. non-black colored pigments) which may be, for example, or be comprised of, for example, white colored titanium dioxide pigment, which may, if desired, be combined with other pigment colorants, used in an amount of, for example, about 1 to about 60 phr.

The tire can be built, shaped, molded and cured by various methods which will be readily apparent to those having skill in the art.

### BRIEF DESCRIPTION OF THE DRAWINGS

To further understand the invention, drawings are provided herewith in a form of FIG. 1 (FIG. 1) as well as FIG. 2, FIG. 3, FIG. 4, FIG. 5 and FIG. 6.

FIG. 1 and FIG. 2 depict a composite comprised of a base rubber layer and an outer, marking rubber layer.

FIG. 3, FIG. 4, FIG. 5 and FIG. 6 depict tire sections, including a portion of its sidewall, which contains a plurality of spaced apart marking, layered composites on its surface.

### THE DRAWINGS

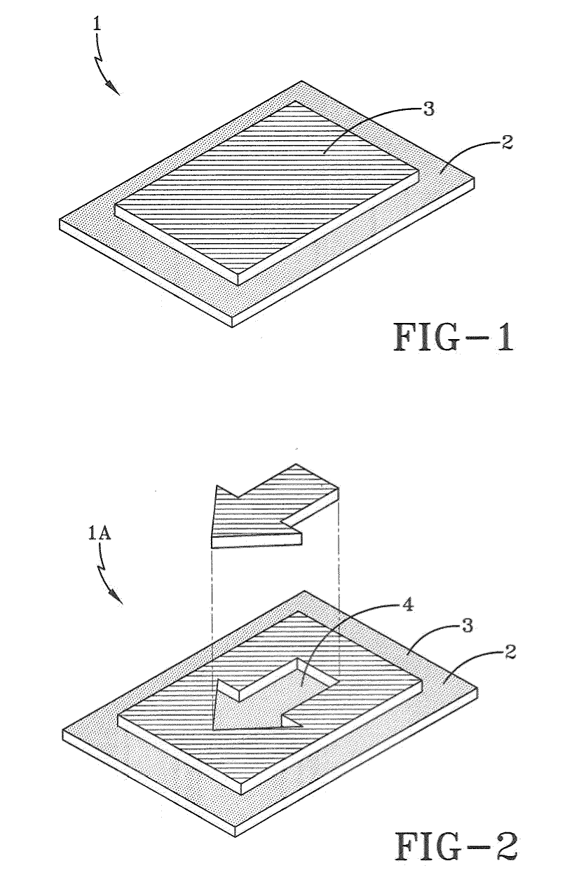

In FIG. 1, a partially pre-cured integral layered (laminate) composite (1) is presented as being comprised of a base rubber layer (2) which is integral with (in the sense of being partially co-cured with to a vulcanization degree of about 50 percent of its rheometric delta torque at 150° C.) an outer, marking rubber layer (3). The base rubber layer (2) is comprised of a black colored, carbon black-containing sulfur curable, butyl rubber-based rubber composition. The outer, marking rubber layer is comprised of sulfur curable butyl rubber-based rubber composition which contains white colored titanium dioxide pigment colorant (to an exclusion of black colored carbon black) which renders it with a white color which contrasts with the black color of the base rubber layer (2). The base rubber layer (2) extends beyond the peripheral edges of the outer, marking rubber layer (3).

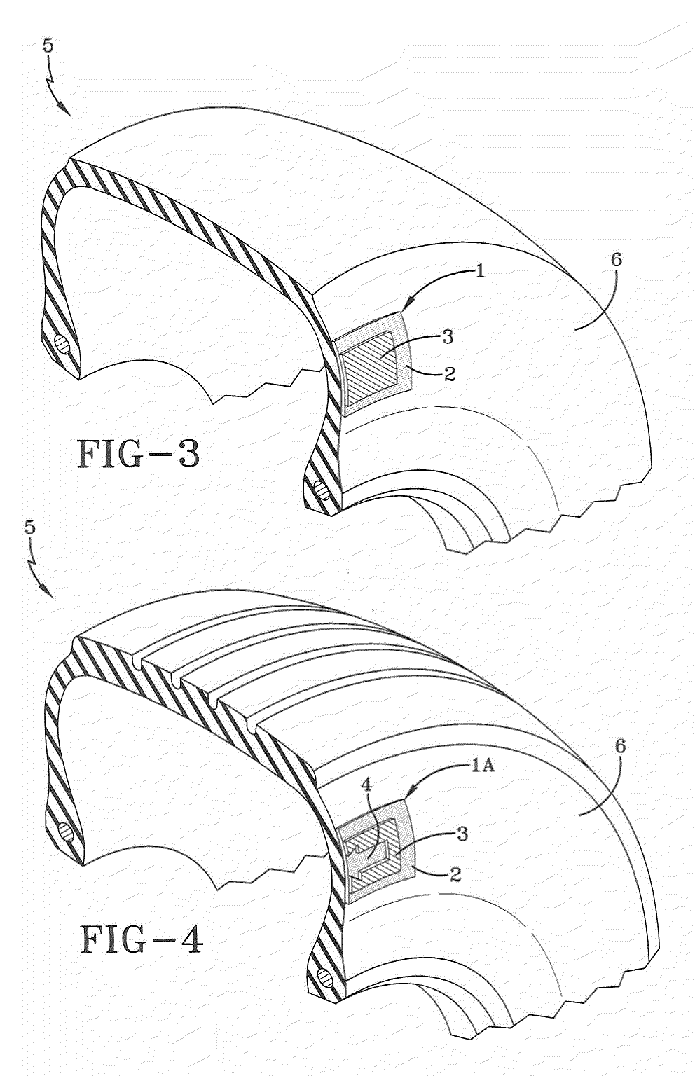

In FIG. 2, the partially pre-cured integral layered composite of FIG. 1 and identified in the drawing as (1A) is presented in which a portion of the outer, marking layer (2) is cut out portion (4) in a shape of a directional arrow to reveal the underlying contrasting black colored base rubber layer (2) which is exposed through the cutout opening (4).

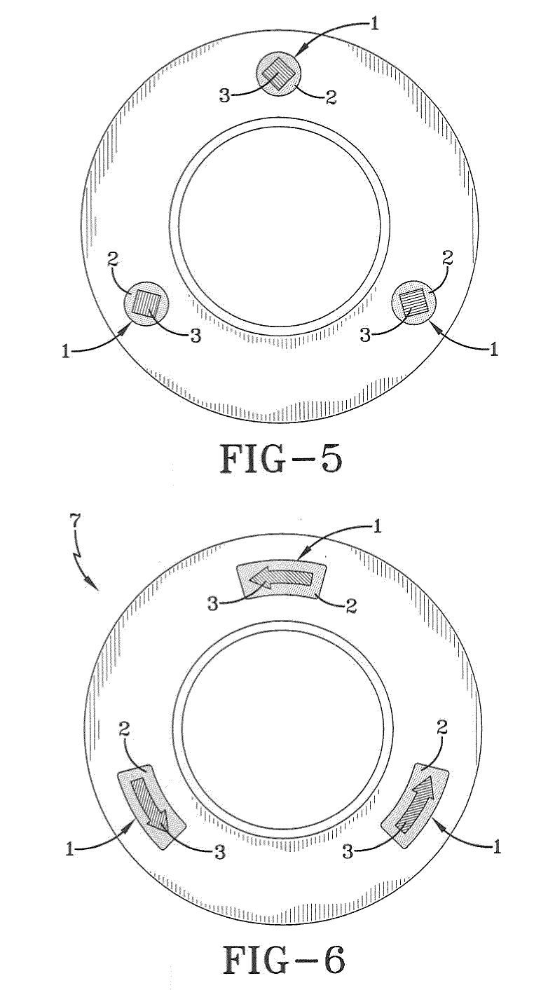

In FIG. 3, a cross-section of a pneumatic rubber tire (5) is presented as an assembly comprised of the tire rubber sidewall (6) integral and co-cured with a partially pre-cured integral layered composite (1) of FIG. 1 with its identifying contrastingly colored outer marking rubber layer (3) and its underlying base rubber layer (2).

In FIG. 4, a cross-section of a pneumatic rubber tire (5) is presented as an assembly comprised of the tire rubber sidewall (6) integral and co-cured with the partially pre-cured integral layered composite (1A) of FIG. 2 with its identifying contrastingly colored outer marking rubber layer (3) with its cutout portion (4) and its underlying base rubber layer (2).

In FIG. 5, a pneumatic rubber tire sidewall (7) is presented having a plurality, (namely three) of spaced apart composites of the integral laminate composite (1) of FIG. 1 co-cured thereon in a form of, however, a circular shaped base layer (2) and a contrastingly colored outer, square shaped marking rubber layer (3).

In FIG. 6, a pneumatic rubber tire sidewall (7) is presented having a plurality, (namely three) of spaced apart composites of an integral laminate composite (8) of FIG. 3 co-cured thereon in a form of an arrow shaped contrastingly colored outer, marking rubber layer (3) with its underlying rectangular shaped base black colored rubber layer (2).

The practice of this invention is further illustrated by reference to the following examples which are intended to be representative rather than restrictive of the scope of the invention. Unless otherwise indicated, all parts and percentages are by weight.

### EXAMPLE I

Rubber compositions for use in preparing two individual laminate rubber composites were prepared. For such preparation, outer, marking, rubber layers were prepared and a base rubber layer were prepared by individually blending ingredients in an internal rubber mixer comprised of the formulations illustrated in Table 1.

Sample A represents a white colored rubber composition, Sample B represents a yellow colored rubber composition, intended for use as a outer marking layer of a dual layered overlay for said tire sidewall. Sample C represents a base layer (to underlie said outer marking rubber layer and positioned next to the tire sidewall) of a dual layered integral laminate composite for said tire sidewall.

The respective ingredients were individually mixed in an internal rubber mixer as a first non-productive mixing step (NP1), to the exclusion of sulfur and vulcanization accelerator, for about 170 minutes to a temperature in a range of about 130° C. to 160° C., dumped from the mixer, sheeted out from an open roll mill and allowed to cool below 40° C.

The resulting composition was then mixed in an internal rubber mixer as a productive mixing step (P) in which sulfur, vulcanization accelerator(s) and zinc oxide were added for a mixing period in a range of from about 0.5 to about 5 minutes to a temperature in a range of from about 80° C. to about 120° C.

The preparation of rubber mixtures by use of sequential combination of non-productive and productive mixing steps, in general, is well known to those having skill in such art with the amounts being reported in terms of rounded whole numbers.

TABLE 1

| | Sample | | |
|---|---|---|---|
| | White, | Yellow, | |
| | Marking | Marking | |
| | Outer | Outer | Base |
| | Layer A | Layer B | Layer C |
| Non-Productive Mixing (NP) | | | |
| Clorobutyl rubber¹ | 60 | 60 | 65 |
| Natural cis 1,4-polyisoprene rubber | 35 | 35 | 30 |
| EPDM rubber² | 5 | 5 | 5 |
| Carbon black³ | 0 | 0 | 50 |
| Rubber processing oil, tackifying | 8 | 5 | 8 |
| resin and rosin oil | | | |
| Fatty acid⁴ | 1 | 1 | 2 |
| Clay and titanium dioxide⁵ | 85 | 95 | 0 |
| Yellow pigment | 0 | 3 | 0 |
| (yellow colored colorant)⁶ | | | |
| Antidegradant | 1 | 1 | 0 |
| Productive Mixing (P) | | | |
| Sulfur | 1.2 | 1.2 | 0.75 |
| Vulcanization accelerators and retarder⁷ | 2.5 | 1.8 | 1 |
| Zinc oxide | 3 | 5 | 5 |

¹Chlorobutyl rubber as Chlorobutyl 1066 ™ from the Exxon Mobil Company as a chlorinated copolymer of isobutylene and a minor amount of isoprene
²EPDM rubber as Royalene 505 ™ from the Uniroyal Chemical Company as a terpolymer of ethylene, propylene (60/40 ratio) and about 8 weight percent of ethylidene norbornene. The EPDM reportedly had a Mooney viscosity (ML1 + 4) at 125° C. of about 55.
³N550 an ASTM designation for a rubber reinforcing carbon black
⁴An indusrial stearic acid composed of stearic acid and also containing palmitic acid and oleaic acid.
⁵Kaolin clay and titanium dioxide as, variously, Titanol 1000 ™ from Kronos Titan, and TiPure R101 ™ from DuPont Pigments and minor amount of bluing (ultra marine blue) where desired to enhance the white color of the titanium dioxide
⁶Yellow pigment as Stan-Tone D1102 ™ from Excel Polymers
⁷Sulfenamide, diphenyl guanidine and Santogard PVI-PDR-D ™ , respectively, from Flexsys

Various properties of Samples A, B and C are reported in the following Table 2. Vulcanized Samples were cured at about 170° C. for about 12 minutes, unless otherwise indicated.

TABLE 2

| | Samples | | |
|---|---|---|---|
| | A | B | C |
| Chlorobutyl rubber | 60 | 60 | 65 |
| Natural cis 1,4-polyisoprene rubber | 35 | 35 | 30 |
| EPDM rubber | 5 | 5 | 5 |
| Die Rheometer (ODR), 150° C.¹ | | | |
| Maximum torque (dNm) | 22.88 | 22.33 | 23.25 |
| Minimum torque (dNm) | 4.46 | 3.98 | 7.4 |
| Delta Torque (Max-Min Torque) | 18.42 | 18.35 | 15.85 |
| T50 (minutes to reach 50% of Delta Torque) | 10.17 | 12.67 | 13.31 |
| T80 (minutes to reach 80% of Delta Torque) | 12.67 | 15.07 | 22.13 |
| T90 (minutes to reach 90% of Delta Torque) | 15.72 | 17.7 | 33.21 |
| RPA (191° C. cure cycle, 1 Hz, 100° C.)² | | | |
| G′at 10% strain, (MPa) | 0.526 | 0.524 | 0.700 |
| G′at 10% strain, (MPa) | 0.087 | 0.090 | 0.129 |
| Tan delta at 10% strain | 0.165 | 0.170 | 0.184 |
| G′, uncured, 100° C., 15% strain, | 0.112 | 0.104 | 0.197 |
| 0.833 Hz (MPa) | | | |

¹Data obtained according to ASTM D2084 with a Die Rheometer instrument (ODR), Model ODR Rheometer ODR2000 ™ from Alpha Technologies, used for determining cure characteristics of elastomeric materials, such as for example maximum, minimum and delta torque and time in minutes to reach various degrees of sulfur vulcanization at a temperature, for example at 150° C., such as, for example T50, T80, and T90 (time in minutes) to reach 50, 80 and 90 percent, respectively, of delta torque as the difference between its maximum and minimum torque values obtained by the ODR instrument.
²Data obtained according to Rubber Process Analyzer as RPA 2000 ™ instrument by Alpha Technologies, formerly the Flexsys Company and formerly the Monsanto Company. References to an RPA-2000 instrument may be found in the following publications: H. A. Palowski, et al, Rubber World, June 1992 and January 1997, as well as Rubber & Plastics News, April 26 and May 10, 1993.

From Table 2 it can be seen that typical rubber properties are obtained.

### EXAMPLE II

A large tire of size 18.00-25 EV-5D, 40 ply is prepared having a rubber sidewall which contains three individual integral spaced apart multilayered colored rubber laminate composites on its surface of the type shown in FIG. 3 in a manner shown in FIG. 6.

In particular, three partially sulfur pre-cured rubber integral layered (laminate) composites are prepared and applied to the surface of an uncured tire sidewall rubber surface in a spaced apart configuration (spaced apart from each other in an annular configuration at a substantially equal distance from each other on the uncured tire sidewall) to form an assembly thereof.

The assembly is cured in a suitable tire mold with the laminate composites being thereby co-cured with the tire sidewall to become integral with the tire sidewall.

The layered rubber composites are comprised of a black colored (carbon black-containing) base sulfur curable rubber layer which underlies a contrastingly yellow colored outer (marking) sulfur curable rubber layer of the type shown in FIG. 1 with the underlying base rubber layer extending beyond the peripheral edges of the outer rubber layer. The black colored base rubber layer is comprised of the rubber composition C of Example I and the outer yellow colored layer is comprised of the rubber composition B of Example I.

The base and outer rubber layers are sulfur partially cured together in a suitable press at a temperature of about 150° C. with Mylar™ plastic sheets being placed between the composite (two layered rubber composite) and then pressed to form a smooth surfaced integral composite thereof to an extent of about 50 percent of its rheometric delta torque value (maximum torque less minimum torque according to ASTM D 2084 by the aforesaid OTR instrument at 150° C.).

The partially cured composite, after removal of the Mylar plastic sheets, is then applied to the uncured tire sidewall with the partially cured base rubber layer of the composite facing the uncured surface of the rubber tire sidewall to form the aforesaid assembly thereof. The assembly is then cured in a suitable tire mold to form an integral assembly thereof

The aforesaid outer colored rubber layer and base rubber layer are of substantially rectangular dimensions as being about 16.5 mm by about 18.3 mm (millimeters) and about 25.7 mm by 27.4 mm, respectively, with the base layer extending beyond the peripheral edges of the outer colored layer, and with individual thicknesses of about 0.066 mm each.

While certain representative embodiments and details have been shown for the purpose of illustrating the invention, it will be apparent to those skilled in this art that various changes and modifications may be made therein without departing from the spirit or scope of the invention.

1. (canceled)

2. (canceled)

3. (canceled)

4. (canceled)

5. (canceled)

6. (canceled)

7. (canceled)

8. A method of preparing a tire having a rubber sidewall with at least one multi-layered rubber composite on and integral with the surface of said rubber sidewall comprises the steps of:
(A) preparing a multi-layered rubber composite comprised of:
(1) an outer, visible marking rubber layer comprised of a non-black colored sulfur curable rubber composition containing a colorant having a color other than a black color to thereby color said marking rubber layer a color other than a black color; and
(2) a base rubber layer underlying said outer marking rubber layer comprised of a black colored, carbon black-containing, sulfur curable rubber composition, wherein said base rubber layer extends beyond the peripheral edges of said marking rubber layer;
(B) partially co-sulfur curing said base rubber layer and said outer marking rubber layer of said multi-layered composite together to form an integral composite thereof,
(C) applying at least one of said integral multi-layered composites to an outer surface of an uncured rubber sidewall of a pneumatic tire to form an assembly thereof;
wherein the face of said base rubber layer opposite said integral marking rubber layer of said multi-layered composite is positioned against said outer surface of said tire rubber sidewall;
(D) co-curing said assembly in a suitable mold under conditions of elevated temperature and pressure.

9. The method of claim 8 wherein said multi-layered rubber composite is partially sulfur cured, prior to said application to the surface of said uncured rubber sidewall, to a degree of about 50 to about 80 percent of its rheometric delta torque value as the difference between its rheometric maximum torque and minimum torque according to ASTM D2084 as determined by a rheometer instrument at 150° C.

10. The method of claim 8 wherein said laminate composite is partially pre-cured prior to its application to said uncured rubber sidewall to thereby substantially retain its shape and inhibit the migration of staining ingredients during the curing of the assembly of sidewall and laminate composite.

11. The method of claim 8 wherein the rubber composition of said marking rubber layer contains reinforcing filler comprised of at least one of clay, titanium dioxide and precipitated silica and which contains a colorant having a color other than a black color to thereby color said outer marking rubber layer a color which contrasts with the black color of the carbon black-containing base layer.

12. The method of claim 8 wherein the rubber composition of said rubber sidewall contains at least one amine-based antidegradant and at least one rubber processing oil.

13. The method of claim 8 wherein said base layer of said multi-layered composite is comprised of said butyl rubber type elastomer(s) to thereby retard the migration of said amine-based antidegradant to said outer colored marking layer of said multi-layered composite.

14. The method of claim 8 wherein a plurality of said multi-layered partially pre-sulfur cured composites are applied to said outer surface of said tire rubber sidewall, wherein said rubber composites are configured in an annular spaced apart configuration relative to each other, to form said assembly.

15. The method of claim 8 wherein the rubber composition of said base rubber layer of said multi-layered rubber composite is comprised of, based on parts by weight per 100 parts by weight rubber (phr):
(A) at least one elastomer comprised of about 40 to about 90 phr of at least one of:
(1) butyl rubber comprised of a copolymer of isobutylene and about 0.5 to about 5 mole percent of a conjugated diene, wherein said conjugated diene is comprised primarily of isoprene;
(2) halogenated butyl rubber comprised of said butyl rubber halogenated with bromine or chlorine; and
(3) brominated copolymer of isobutylene and pare-methylstyrene; and
(B) from about 10 to about 60 phr of additional elastomer(s) comprised of at least one of:
(1) conjugated diene-based elastomer, and
(2) EPDM rubber.

16. The method of claim 8 wherein the rubber composition of said outer rubber layer of said composite is be comprised of, based on parts by weight per 100 parts by weight rubber (phr):
(A) at least one elastomer comprised of about 40 to about 90 phr of at least one of:
(1) butyl rubber comprised of a copolymer of isobutylene and about 0.5 to about 5 mole percent of a conjugated diene, wherein said conjugated diene is comprised primarily of isoprene;
(2) halogenated butyl rubber comprised of said butyl rubber halogenated with bromine or chlorine; and
(3) brominated copolymer of isobutylene and pare-methylstyrene; and
(B) from about 10 to about 60 of additional elastomer(s) comprised of at least one of:
(1) conjugated diene-based elastomer, and
(2) EPDM rubber.

17. (canceled)

18. (canceled)

19. (canceled)

20. (canceled)
